(19) United States
(12) Patent Application Publication
(10) Pub. No.: US 2021/0119819 A1
(43) Pub. Date: Apr. 22, 2021

(54) IN-VEHICLE COMMUNICATION SYSTEM, IN-VEHICLE RELAY DEVICE, COMMUNICATION PROGRAM, AND COMMUNICATION METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yuki Sano, Yokkaichi-shi, Mie (JP); Katsuya Ikuta, Yokkaichi-shi, Mie (JP); Tsuyoshi Kontani, Yokkaichi-shi, Mie (JP)

(21) Appl. No.: 17/044,496

(22) PCT Filed: May 17, 2019
(86) PCT No.: PCT/JP2019/019694

§ 371 Date: Oct. 1, 2020

(30) Foreign Application Priority Data
May 29, 2018 (JP) 2018-102626

(51) Int. Cl. H04L 12/28; H04L 12/66; B60R 16/023

(52) U.S. Cl. CPC H04L 12/28; H04L 2012/40273; B60R 16/023; H04L 12/66

(57) ABSTRACT

An in-vehicle communication system comprises a plurality of in-vehicle relay devices, each including a plurality of first connection units, an in-vehicle communication device connected to each one of the first connection units, a plurality of second connection units to which another one of the in-vehicle relay devices is connected, and a relay processing unit that relays messages between the in-vehicle communication devices connected to the first connection units and the in-vehicle relay devices connected to the second connection units, wherein two of the in-vehicle relay devices are connected to one another via two or more communication lines. The in-vehicle relay devices each include a storage unit that stores relationships between identification information attached to messages received via the first connection units and the second connection units corresponding to transmission destinations of the messages, and updates the relationships according to a communication status of communication via the second connection units.

### CROSS-REFERENCE TO RELATED APPLICATIONS

This application is the U.S. national stage of PCT/JP2019/019694 filed on May 17, 2019, which claims priority of Japanese Patent Application No. JP 2018-102626 filed on May 29, 2018, the contents of which are incorporated herein.

### TECHNICAL FIELD

The present disclosure relates to an in-vehicle communication system, an in-vehicle relay device, a communication program, and a communication method for relaying messages transmitted and received by a plurality of in-vehicle communication devices installed in a vehicle.

### BACKGROUND

In recent years, the number of Electronic Control Units (ECU) installed in a vehicle has been increasing. Each ECU communicates with other ECUs, exchanges information, and executes various processing. With the increase in the number of ECUs in a vehicle, the number of communication lines inside vehicles provided for communication by the ECUs has also increased, and there is concern surrounding vehicle weight increase and diminishing space to dispose communication lines inside vehicles.

In JP 2015-67187A, a vehicle control system is described which has a configuration in which the inside of a vehicle is divided into a plurality of regions, in each region, a plurality of functional ECUs are connected to a relay ECU on a first network, and the plurality of relay ECUs are connected to one another on a second network.

However, in the vehicle control system described in JP 2015-67187A, in the case in which the communication amount increases between the plurality of functional ECUs provided in the different regions, the communication band between the relay ECUs that relay these communications is put under strain, which may lead to communication delay.

The present disclosure was made in light of such circumstances and has an object of providing an in-vehicle communication system, an in-vehicle relay device, a communication program, and a communication method capable of reducing the number of communication lines provided in a vehicle and preventing communication delay.

### SUMMARY

An in-vehicle communication system according to the present aspect comprises a plurality of in-vehicle relay devices. Each of the in-vehicle relay devices include a plurality of first connection units, and an in-vehicle communication device is connected to each one of the first connection units; and a plurality of second connection units to which another one of the in-vehicle relay devices is connected. A relay processing unit is configured to execute processing to relay messages between the in-vehicle communication devices connected to the first connection units and the other one of in-vehicle relay devices connected to the second connection units, wherein two of the in-vehicle relay devices are connected to one another via two or more communication lines.

An in-vehicle relay device according to the present aspect comprises: a plurality of first connection units, an in-vehicle communication device being connected to each one of the first connection units; a plurality of second connection units to which another in-vehicle relay device is connected; and a relay processing unit configured to execute processing to relay messages between the in-vehicle communication devices connected to the first connection units and the other in-vehicle relay device connected to the second connection units.

A communication program according to the present aspect is a communication program that causes an in-vehicle relay device, which is provided with a plurality of first connection units, an in-vehicle communication device being connected to each one of the first connection units, and a plurality of second connection units to which another in-vehicle relay device is connected, wherein two or more of the second connection units are connected to the other in-vehicle relay device, to execute processing to receive messages from the in-vehicle communication devices via the first connection units; and relay received messages to the other in-vehicle relay device via one or the plurality of second connection units.

A communication method according to the present aspect comprises: via an in-vehicle relay device provided with a plurality of first connection units, an in-vehicle communication device being connected to each one of the first connection units, and a plurality of second connection units to which another in-vehicle relay device is connected, wherein two or more of the second connection units are connected to the other in-vehicle relay device, receiving messages from the in-vehicle communication devices via the first connection units; and relaying received messages to the other in-vehicle relay device via one or the plurality of second connection units.

Note that the present application can be realized not only as an in-vehicle communication system provided with the advantageous processing unit described above, but also as a communication method including such advantageous processing steps and a communication program for causing a computer to execute these steps. Also, a portion of all of the in-vehicle communication system can be realized as a semiconductor integrated circuit or as a system that includes the in-vehicle communication system.

### Advantageous Effects of Disclosure

According to the foregoing, the number of communication lines provided in a vehicle can be reduced and communication delay can be prevented.

### BRIEF DESCRIPTION OF DRAWINGS

FIG. 1 is a block diagram illustrating the configuration of an in-vehicle communication system according to the present embodiment.

FIG. 2 is a block diagram illustrating the configuration of a GW according to the present embodiment.

FIG. 3 is a schematic diagram illustrating an example of a transmission destination map.

FIG. 4 is a schematic diagram illustrating an example of processing to update a transmission destination map executed by a GW according to a first embodiment.

FIG. 5 is a flowchart illustrating the process of processing to update the transmission destination map executed by the GW according to the first embodiment.

FIG. 6 is a schematic diagram illustrating the configuration of an in-vehicle communication system according to a modified example.

FIG. 7 is a schematic diagram illustrating an example of processing to update a transmission destination map executed by a GW according to a second embodiment.

FIG. 8 is a flowchart illustrating the process of processing to update a transmission destination map executed by a GW according to a third embodiment.

### DETAILED DESCRIPTION OF PREFERRED EMBODIMENTS

Firstly, embodiments of the present disclosure will be listed and described. One or more parts of the embodiments described below may be combined in a discretionary manner.

An in-vehicle communication system according to the present aspect comprises: a plurality of in-vehicle relay devices. Each of the in-vehicle relay devices include a plurality of first connection units, an in-vehicle communication device being connected to each one of the first connection units; and a plurality of second connection units to which another one of the in-vehicle relay devices is connected. A relay processing unit configured to execute processing to relay messages between the in-vehicle communication devices connected to the first connection units and the other one of in-vehicle relay devices connected to the second connection units, wherein two of the in-vehicle relay devices are connected to one another via two or more communication lines.

In the present aspect, the plurality of communication lines that the in-vehicle communication devices are connected are connected to the in-vehicle relay devices, and the in-vehicle relay devices relay the transmitting and receiving of messages between the communication lines. In the vehicle, the plurality of in-vehicle relay devices are installed, and the plurality of in-vehicle relay devices are connected to one another via the communication lines. With this configuration, compared to a configuration in which all of the in-vehicle communication devices connect to one in-vehicle relay device, the number of communication lines provided in the vehicle can be reduced.

Also, the in-vehicle relay devices installed in the vehicle are connected in a manner such that two of the in-vehicle relay devices are connected via two or more communication lines and can transmit and receive messages via the plurality of communication lines. With this configuration, the communication capacity for communications between the in-vehicle relay devices where bottlenecking is likely to occur, can be increased. This allows communication delays to be prevented. Also, by increasing the communication capacity between the in-vehicle relay devices, the communication speed at the communication lines can be slowed to reduce the amount of noise in the communications.

The two or more communication lines connecting the two in-vehicle relay devices preferably follow an identical communication protocol.

In the present aspect, the two or more communication lines connecting the two in-vehicle relay devices follow an identical communication protocol. In this way, there is no need for processing by the in-vehicle relay devices to convert the message format following a communication protocol, for example, and communication delay caused by conversion processing is prevented. Furthermore, the configuration of the in-vehicle relay device can be prevented from becoming too complex, thus minimizing or preventing an increase in the cost of the in-vehicle relay device.

The in-vehicle relay devices each preferably include: a storage unit configured to store relationships between identification information attached to messages received via the first connection units and the second connection units corresponding to transmission destinations of the messages; a monitor processing unit configured to execute processing to monitor a communication status of communication via the second connection units; and an update processing unit configured to execute processing to update the relationships according to the communication status monitored by the monitor processing unit.

In the present aspect, the relationships between the identification information that are attached to the messages and the communication lines corresponding to the transmission destinations of the messages are stored in the storage unit by the in-vehicle relay device. In the case in which a message is received that is to be transmitted to the other in-vehicle relay device, the in-vehicle relay device selects the communication line on the basis of the stored relationships, outputs the message to the selected communication line, and transmits the message to the other in-vehicle relay device. Also, the in-vehicle relay device monitors the communication status at the plurality of communication lines connected to the other in-vehicle relay device. For the communication status, for example, the data amount of the messages transmitted and received at the communication line, power consumption of the communication IC (Integrated Circuit) executing communication, and the like can be used. The in-vehicle relay device executes processing to update the relationships stored in the storage unit on the basis of the results from monitoring the communication status. In this way, the relationships between the messages and the communication lines for transmitting the messages can be changed depending on the communication status, and by resolving an imbalance in the communication amount between the communication lines, the communication band can be used effectively.

The update processing unit preferably executes processing to update the relationships each time a predetermined amount of time elapses.

In the present aspect, processing to update the relationships stored in the storage unit by the in-vehicle relay device is executed each time a predetermined amount of time elapses. In this way, the relationships can be reviewed each time the predetermined amount of time elapses, and the relationships can be updated to be appropriate to the communication status at that point in time.

The update processing unit preferably executes processing to update the relationships when an imbalance level of the communication status of communication via the second connection units exceeds a threshold.

In the present aspect, processing to update the relationships stored in the storage unit by the in-vehicle relay device is executed when an imbalance level of the plurality of communication lines exceeds a threshold. Because update processing is not executed when the communication status is in a balanced state in this manner, the frequency in which update processing is executed can be reduced and the processing load and power consumption of the in-vehicle relay device can be reduced.

The update processing unit preferably updates the relationships so that a message allocated to a second connection unit of the second connection units with a larger communication amount is allocated to a second connection unit of the second connection units with a smaller communication amount.

In the present aspect, the relationships stored in the storage unit by the in-vehicle relay device are updated so that a message allocated to the communication line determined to have a larger communication amount via monitoring is allocated to the communication line with a smaller communication amount. By resolving an imbalance in the communication amount between the plurality of communication lines provided between the plurality of in-vehicle relay devices in this manner, the communication band can be used effectively.

The update processing unit preferably updates the relationships so that a message with a predetermined identification information allocated to a second connection unit of the second connection units with a larger communication amount is transmitted via the plurality of second connection units.

In the present aspect, a message with a predetermined identification information allocated to the communication line determined to have a larger communication amount via monitoring is allocated to the plurality of communication lines by the in-vehicle relay device. When a message with a predetermined identification information is needed to be transmitted, the in-vehicle relay device selects the appropriate communication line from among the plurality of communication lines and transmits the message. The communication line may be selected by a method such as alternating between communication lines, by random selection, or the like. In this way, the communication load can be distributed from the communication line with a larger communication amount to the communication line with a smaller communication amount, and an imbalance in the communication amount between the plurality of communication lines can be resolved. This allows the communication band to be used effectively.

An in-vehicle relay device according to the present aspect comprises: a plurality of first connection units, an in-vehicle communication device being connected to each one of the first connection units; a plurality of second connection units to which another in-vehicle relay device is connected; and a relay processing unit configured to execute processing to relay messages between the in-vehicle communication devices connected to the first connection units and the other in-vehicle relay device connected to the second connection units.

In the present aspect, in a similar manner to aspect (1), the number of communication lines provided in a vehicle can be reduced and communication delay can be prevented.

A communication program according to the present aspect is a communication program that causes an in-vehicle relay device, which is provided with a plurality of first connection units, an in-vehicle communication device being connected to each one of the first connection units, and a plurality of second connection units to which another in-vehicle relay device is connected, wherein two or more of the second connection units are connected to the other in-vehicle relay device, to execute processing to: receive messages from the in-vehicle communication devices via the first connection units; and relay received messages to the other in-vehicle relay device via one or the plurality of second connection units.

In the present aspect, in a similar manner to aspect (1), the number of communication lines provided in a vehicle can be reduced and communication delay can be prevented.

A communication method according to the present aspect comprises: via an in-vehicle relay device provided with a plurality of first connection units, an in-vehicle communication device being connected to each one of the first connection units, and a plurality of second connection units to which another in-vehicle relay device is connected, wherein two or more of the second connection units are connected to the other in-vehicle relay device, receiving messages from the in-vehicle communication devices via the first connection units; and relaying received messages to the other in-vehicle relay device via one or the plurality of second connection units.

In the present aspect, in a similar manner to aspect (1), the number of communication lines provided in a vehicle can be reduced and communication delay can be prevented.

A specific example of an in-vehicle communication system according to an embodiment of the present disclosure will be described with reference to the drawings. Note that the present disclosure is not limited to these examples. The present disclosure is defined by the scope of the claims, and all modifications that are equivalent to or within the scope of the claims are included.

### First Embodiment

### System Configuration

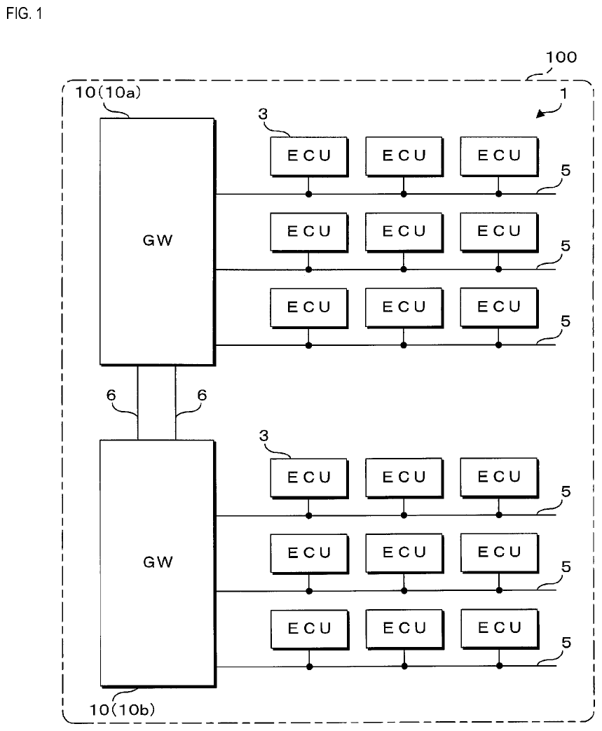

FIG. 1 is a block diagram illustrating the configuration of an in-vehicle communication system according to the present embodiment. The in-vehicle communication system 1 according to the present embodiment is a system that includes, in a vehicle 100, a plurality of ECUs 3 and a plurality of Gate Ways (GW) 10. In the system, the plurality of ECUs 3 and GWs 10 transmit and receive messages via communication lines 5, 6. In the configuration of the in-vehicle communication system 1 illustrated in FIG. 1, for example, two GWs 10 are installed in the vehicle 100, the two GWs 10 are connected to one another via two communication lines 6, three communication lines 5 are connected to each GW 10, and three ECUs 3 are connected to each communication line 5. Hereinafter, when one of the two GWs 10 is referred to, to distinguish between the two, GW 10a and GW 10b with different reference signs will be used as illustrated in FIG. 1. Note that the number of ECUs 3, the number of GWs 10, the number of communication lines 5, 6, the connection mode and the network configuration of the devices provided in the in-vehicle communication system 1, and the like are not limited to the examples illustrated in the drawings.

The ECUs 3 installed in the vehicle 100 may include various ECUs, such as an ECU that controls the operation of the engine of the vehicle 100, an ECU that controls the locking and unlocking of a door, an ECU that controls turning a light on and off, an ECU that controls the operation of an airbag, an ECU that controls the operation of the Antilock Brake System (ABS), and the like. The ECUs 3 are each connected to one of the communication lines 5 disposed in the vehicle 100 and are capable of transmitting and receiving messages with other ECUs 3 via the communication lines 5 and the GWs 10.

The GWs 10 each have a plurality of the communication lines 5 connected to them and are capable of transmitting and receiving messages with the plurality of ECUs 3 via the communication lines 5. The GW 10 which receives a message transmitted by one of the ECUs 3 determines whether relay is required on the basis of an ID attached to the received message and transmits a message requiring relay from one of the communication lines 5 from which the message was not received. For this, the GWs 10 include a transmission destination map storing the relationships between IDs that are attached to messages and the communication lines 5 that are transmission destinations of messages.

In the in-vehicle communication system 1, a message from one of the ECUs 3 connected to the GW 10a can be transmitted to one of the ECUs 3 connected to the GW 10b. In this case, the GW 10a that receives the message from the ECU 3 determines whether relay to the GW 10b is required on the basis of the ID attached to the message and transmits the message to the GW 10b by outputting the message from the communication line 6. The GW 10b that receives a message from the GW 10a via the communication line 6 determines which communication line 5 is the relay destination on the basis of the ID attached to the received message and transmits the message to the communication line 5 which is the relay destination. Transmitting messages from the GW 10b to the GW 10a is executed in a similar manner.

In the in-vehicle communication system 1 according to the present embodiment, the two GWs 10 are connected via the two communication lines 6. The two communication lines 6 follow the same communication protocol, and, for example, a Controller Area Network (CAN), Ethernet (trade name), or a similar communication protocol can be employed. In the present embodiment, the communication speed is the same, irrespective of which communication line 6 is used. However, the two communication lines 6 may follow different communication protocols, and communication speed may differ.

The GW 10, in the case in which a message is to be transmitted to the other GW 10, selects one communication line 6 from the two communication lines 6. The GW 10, by outputting the message via the selected communication line 6, transmits the message to the other GW 10 via this communication line 6. Here, the GW 10 selects the communication line 6 via which the message is to be transmitted on the basis of the ID attached to the message. For this, the GWs 10 stores a transmission destination map of the relationships between the IDs that are attached to messages and the communication lines 6 for transmitting the messages.

Also, in the in-vehicle communication system 1 according to the present embodiment, the GWs 10 each monitor the communication status of the communication lines 6. Examples of the communication status monitored by the GWs 10 include, but are not limited to, the amount of transmitted data or the amount of received data for each communication line 6, the power consumption of a communication IC such as a transceiver that executes communication processing relating to the communication lines 6, and the like. The GWs 10 according to the present embodiment, execute processing to update the relationships between the message IDs and the transmission destinations stored in the transmission destination map on the basis of the results from monitoring the communication status. The processing to update the transmission destination map will be described in detail below.

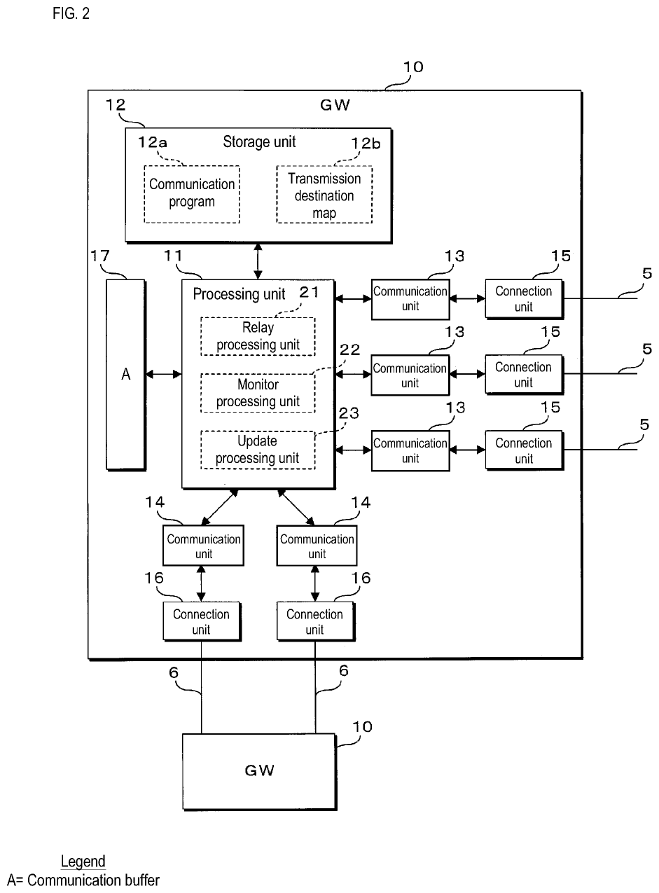

FIG. 2 is a block diagram illustrating the configuration of the GWs 10 according to the present embodiment. Note that the two GWs 10 provided in the in-vehicle communication system 1 according to the present embodiment have substantially the same configuration. Thus, FIG. 2 illustrates the detailed configuration of only one GW 10, and the detailed configuration of the other GW 10 is omitted. The GW 10 according to the present embodiment includes a processing unit (processor) 11, a storage unit (storage) 12, communication units (transceiver) 13, 14, connection units (connector) 15, 16, a communication buffer 17, and the like.

The processing unit 11 is configured using, for example, a computational processing device, such as a Central Processing Unit (CPU), a Micro-Processing Unit (MPU), or the like. The processing unit 11 is capable of executing various types of processing by reading out and executing a program stored in the storage unit 12. The processing unit 11 of the present embodiment executes processing to relay a message, processing to monitor the communication status of the communication lines 6, processing to update a transmission destination map 12b stored in the storage unit 12, and the like by reading out and executing a communication program 12a stored in the storage unit 12.

The storage unit 12 is configured, for example, using a memory element, such as a flash memory, Electrically Erasable Programmable Read Only Memory (EEPROM), and the like. The storage unit 12 stores various programs executed by the processing unit 11 and various data required in the processing by the processing unit 11. The storage unit 12 of the present embodiment stores the communication program 12a executed by the processing unit 11 and the transmission destination map 12b used by the processing unit 11 to relay messages. Note that the communication program 12a, for example, may be written to the storage unit 12 when the GW 10 is manufactured, may be a program transmitted by a remote server device or the like and acquired by the GW 10 via communication, or may be a program stored in a recording medium, such as a memory card or an optical disk, that is read out by the GW 10 and stored in the storage unit 12.

The connection units 15, 16 are connectors that detachably connect to the communication lines 5, 6. The connection units 15, 16 are configured to be compatible with the shape, protocol, and the like of the communication lines 5, 6 to which they connect. Note that, in FIG. 2, the three connection units 15 for connecting to the communication lines 5 that communicate with the ECU 3 and the two connection units 16 for connecting to the communication lines 6 that communicate with the other GW 10 are illustrated denoted with different reference signs. However, the connection units 15, 16 may be substantially the same in the case in which the communication lines 5, 6 use the same protocol and the communication between the GWs 10 and the ECUs 3 and the communication between the two GWs 10 use the same communication protocol.

The communication units 13, 14 execute processing relating to transmitting and receiving messages via the communication lines 5, 6 connected to the connection units 15, 16. The communication units 13, 14 transmit and receive messages following a communication protocol, such as CAN or Ethernet. The communication units 13, 14 may be configured, for example, using a communication IC such as a CAN transceiver in the case in which a CAN communication protocol is used. The communication unit 13, 14 periodically samples and obtains the potential of the communication line 5, 6 connected to the connection unit 15, 16 to convert the electric signal on the communication line 5, 6 to digital data, which is then sent to the processing unit 11 as a received message. Also, the communication unit 13, 14 converts the message received as digital data from the processing unit 11 to an electric signal and outputs the converted electric signal to the communication line 5, 6 connected to the connection unit 15, 16 to transmit the message. Note that, in FIG. 2, the three communication units 13 for communicating with the ECUs 3 and the two communication units 14 for communicating with the other GW 10 are illustrated denoted with different reference signs. However, the communication units 13, 14 may be substantially the same in the case in which the communication between the GWs 10 and the ECUs 3 and the communication between the two GWs 10 use the same communication protocol.

The communication buffer 17 is configured, for example, using a rewritable memory element, such as a Static Random Access Memory (SRAM), a Dynamic Random Access Memory (DRAM), or the like. The communication buffer 17 temporarily stores messages received from the ECU 3 or the other GW 10.

Also, in the GW 10 according to the present embodiment, a relay processing unit 21, a monitor processing unit 22, an update processing unit 23, and the like are realized in the processing unit 11 as a software functional block by the communication program 12a stored in the storage unit 12 being read out and executed by the processing unit 11. The relay processing unit 21 executes processing to relay a message that the communication unit 13 received from one of the ECUs 3 to another ECU 3. The relay processing unit 21 acquires the ID attached to the message received at the communication unit 13, references the transmission destination map 12b of the storage unit 12, and searches for the transmission destination corresponding to the ID in the transmission destination map 12b. The relay processing unit 21 sends the message to the communication unit 13, 14 designed as the transmission destination in the transmission destination map 12b and makes the communication unit 13, 14 transmit the message to the communication line 5, 6.

The monitor processing unit 22 executes processing to monitor the communication status of the communication lines 6 connected to the connection units 16. The monitor processing unit 22 is capable of monitoring the communication status via various methods, such as calculating the amount of transmission data of the communication lines 6 per unit time, detecting the power consumption of the communication units 14, or the like. However, the monitor processing unit 22 of the present embodiment monitors the communication status by calculating the amount of transmission data per unit time. Note that the communication load on the communication lines 6 can be measured by detecting the power consumption of the communication units 14. However, in the case in which the monitor processing unit 22 detects the power consumption of the communication units 14, hardware such as a sensor for measuring the voltage value applied to the communication units 14 or the current value running through the communication units 14 needs to operate in cooperation with the monitor processing unit 22. Thus, such hardware is omitted from the description of the example illustrated in FIG. 2.

The update processing unit 23 executes processing to update the contents of the transmission destination map 12b stored in the storage unit 12 on the basis of the results of monitoring the communication status of the communication lines 6 by the monitor processing unit 22. The update processing unit 23 acquires the amount of transmission data per unit time of the communication lines 6 and updates the transmission destination map 12b so that a portion of the messages allocated to the communication line 6 with a larger amount of communication data is allocated to the communication line 6 with a smaller amount of communication data to resolve an imbalance in the amount of communication data between the communication lines 6. The update processing of the transmission destination map 12b executed by the update processing unit 23 will be described in detail below.

### Map Update Processing

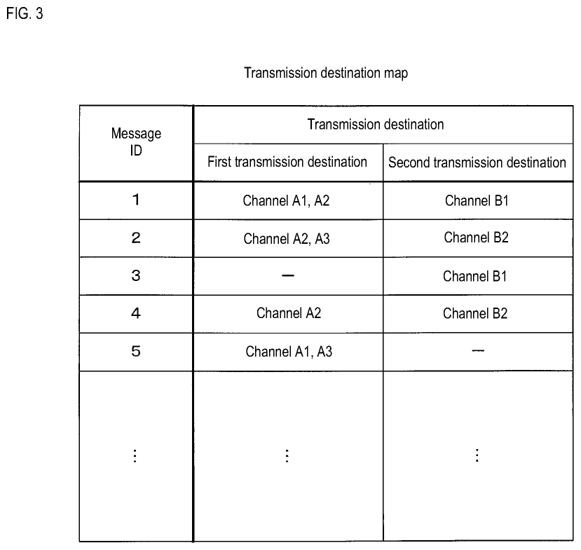

FIG. 3 is a schematic diagram illustrating an example of the transmission destination map 12b. In the transmission destination map 12b of the GW 10 according to the present embodiment, the relationships between the IDs that are attached to messages and the transmission destination of the messages are stored. For the IDs that are attached to messages, a CAN-ID can be used in the case in which messages follow a CAN communication protocol, for example. In the example of the transmission destination map 12b of FIG. 3, the IDs are listed as values 1, 2, 3, 4, 5, etc.

Also, in the example illustrated in FIG. 3, the transmission destinations of the transmission destination map 12b are listed as five channels A1, A2, A3, B1, B2. Of these, channels A1, A2, A3 correspond to the three communication units 13 of the GW 10 and indicate a transmission destination that is one of the communication lines 5 that an ECU 3 is connected to. Channels B1, B2 correspond to the two communication units 14 of the GW 10 and indicate a transmission destination that is one of the communication lines 6 that the other GW 10 is connected to.

Also, the transmission destination of the message stored in the transmission destination map 12b is further divided into a first transmission destination and a second transmission destination. The first transmission destination may be set as one or two of the three channels A1, A2, A3 corresponding to the communication units 13. The second transmission destination may be set as one of the two channels B1, B2 corresponding to the communication units 14. However, in some cases, the first transmission destination or the second transmission destination are not present. Such a case is indicated in FIG. 3 by the symbol “−”.

In the illustrated example of the transmission destination map 12b, the message with the ID “1” has the channel A1 and A2 set as the first transmission destination and the channel B1 set as the second transmission destination. Also, the message with the ID “2” has the channel A2 and A3 set as the first transmission destination and the channel B2 set as the second transmission destination. The message with the ID “3” has no first transmission destination and the channel B1 set as the second transmission destination. The message with the ID “4” has the channel A2 set as the first transmission destination and the channel B2 set as the second transmission destination. The message with the ID “5” has the channel A1 and A3 set as the first transmission destination and no second transmission destination.

In the case in which a message from the ECU 3 is received at the communication unit 13, the relay processing unit 21 of the GW 10 acquires the ID attached to the message and references the transmission destination map 12b of the storage unit 12 on the basis of the acquired ID. In the case in which the ID is “1”, for example, the relay processing unit 21 acquires, from the transmission destination map 12b, the channel A1 and A2 as the first transmission destination of the message and transmits the message to the communication units 13 corresponding to the channels A1 and A2. Also, the relay processing unit 21 acquires, from the transmission destination map 12b, the channel B1 as the second transmission destination of the message with the ID “1” and transmits the message to the communication unit 14 corresponding to the channel B1.

Note that in the transmission destination map 12b of the present example, channels corresponding to the communication lines 5 that the ECUs 3 are connected to are stored as the first transmission destinations. However, a first transmission destination is not required to be stored in the transmission destination map 12b. For example, in the case in which the GW 10 receives a message at one of the communication lines 5 and the GW 10 has a configuration in which messages are relayed to all of the communication lines 5 except this communication line 5, a first transmission destination is not required to be stored in the transmission destination map 12b.

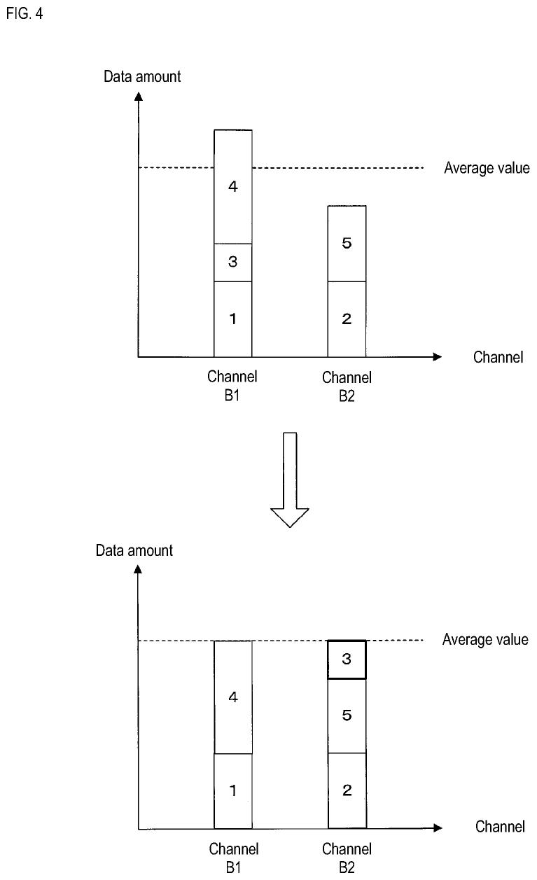

The update processing unit 23 of the GW 10 according to the present embodiment updates the second transmission destination of the transmission destination map 12b according to the communication status of the communication lines 6 monitored by the monitor processing unit 22. FIG. 4 is a schematic diagram illustrating an example of processing to update the transmission destination map 12b executed by the GW 10 according to the first embodiment. The monitor processing unit 22 monitors the communication status of each of the communication lines 6 by measuring the amount of transmission data of each of the communication lines 6 per a unit of time ranging from hundreds of milliseconds to seconds, for example. The upper and lower graphs in FIG. 4 are bar graphs illustrating the amount of transmission data of the channel B1 and B2 per unit time. The values 1 to 5 in each of the bar graphs indicate message ID, and the amount of transmission data for each ID is indicated. Also, the average value of the amount of transmission data of the channel B1 and B2 is indicated by the dashed line. Note that in the example of FIG. 4, the contents of the transmission destination map 12b are different from that of the transmission destination map 12b illustrated in FIG. 3.

In the example of the upper graph of FIG. 4, messages with the ID “1”, “3”, “4” have the channel B1 set as the second transmission destination and messages with the ID “2”, “5” have the channel B2 set as the second transmission destination. The channel B1 has a larger amount of transmission data per unit time. The update processing unit 23, each time a unit time elapses, acquires the amount of transmission data of each channel (communication line 6) measured by the monitor processing unit 22 and calculates the average value of the amount of transmission data of the two channels. The update processing unit 23 allocates messages allocated to the communication line 6 with a larger amount of transmission data to the communication line 6 with a smaller amount of transmission data, changing how the messages are allocated to the channels so that the acquired amount of transmission data of each channel moves toward the average value. In the example illustrated by the lower graph in FIG. 4, the update processing unit 23, the update processing unit 23 has changed the message with the ID “3” from being allocated to the channel B1 to being allocated to the channel B2, thereby evening out the amount of transmission data between the two channels. The update processing unit 23 changes the second transmission destination of the message with the ID “3” included in the transmission destination map 12b of the storage unit 12 from the channel B1 to the channel B2.

Note that the update processing illustrated in FIG. 4 is an example and no such limitation is intended. The update processing unit 23 may even out the amount of transmission data by allocating a message allocated to the communication line 6 with a larger amount of transmission data to the communication line 6 with a smaller amount of transmission data and also allocating a message allocated to the communication line 6 with a smaller amount of transmission data to the communication line 6 with a larger amount of transmission data. For example, in the case in which the monitoring results illustrated in the upper graph of FIG. 4 are obtained, the update processing unit 23 may allocate the message with the ID “4” to the channel B2 and also allocate the message with the ID “5” to the channel B1 to change the transmission destination map 12b. Also, for example, the update processing unit 23 may allocate the message with the ID “4” to the channel B2 and also allocate the message with the ID “2” to the channel B1 to change the transmission destination map 12b.

### Flowchart

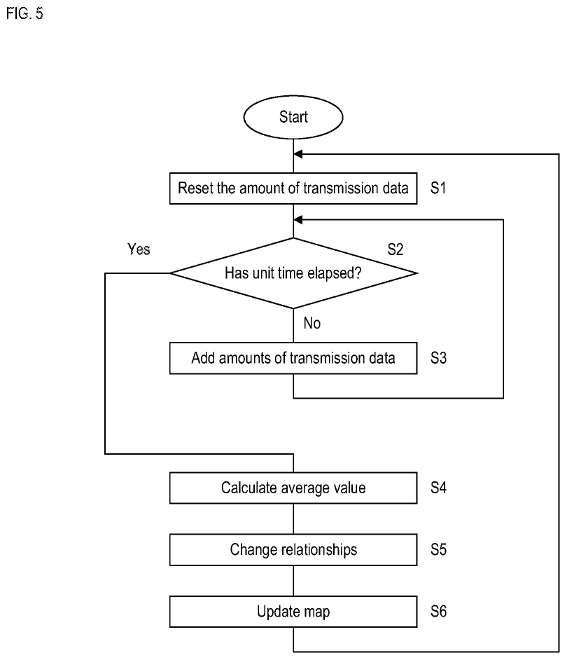

FIG. 5 is a flowchart illustrating the process of processing to update the transmission destination map 12b executed by the GW 10 according to the first embodiment. The monitor processing unit 22 of the processing unit 11 of the GW 10 according to the first embodiment measures the amount of transmission data of the two channels (communication lines 6) via which communication with the other GW 10 is executed and, firstly, resets the amount of transmission data, i.e., the measurement results (step S1). The monitor processing unit 22 determines whether or not a unit time has elapsed since the reset of the amount of transmission data using a timer function or the like provided in the processing unit 11 (step S2). If the unit time has not elapsed (S2: NO), the monitor processing unit 22 adds together the amount of transmission data of each channel corresponding to the message transmission from each channel (step S3), and the process returns to step S2.

If the unit time has elapsed (S2: YES), the update processing unit 23 of the processing unit 11 calculates the average value of the amount of transmission data of the channels measured by the monitor processing unit 22 (step S4). The update processing unit 23 changes the relationships of the messages to the channels so that the amount of transmission data of each channel moves closer to the average value (step S5). The update processing unit 23 updates the transmission destination map 12b of the storage unit 12 to reflect the changed relationships (step S6), and the process returns to step S1.

Note that in this flowchart, the average value is calculated by the update processing unit 23 in step S4. However, this processing is not necessarily required. In a configuration in which the update processing is executed without using the average value, the update processing unit 23 may not calculate the average value. For example, the update processing unit 23 may have a configuration in which the relationships between the messages and the channels are changed to reduce or minimize the difference between the amount of transmission data of the two channels.

### Supplement

The in-vehicle communication system 1 according to the present embodiment with the configuration described above, the plurality of communication lines 5 that the ECUs 3 are connected to are connected to the GWs 10, and the GWs 10 relay transmission and reception communication of messages between the communication lines 5. A plurality (two) of the GWs 10 are installed in the vehicle 100, and the two GWs 10 are connected to one another via the communication lines 6. With this configuration, compared to a configuration in which all of the ECUs 3 connect to one GW 10, the number of communication lines 5 provided in the vehicle 100 can be reduced.

Also, the two GWs 10 installed in the vehicle 100 are connected via two or more communication lines 6 and can transmit and receive messages via the plurality of communication lines 6. With this configuration, the communication capacity for communications between the GWs 10, where bottlenecking is likely to occur, can be increased. This allows communication delays to be prevented. Also, by increasing the communication capacity between the GWs 10, the communication speed at the communication lines 6 can be slowed to reduce the amount of noise in the communications.

Also, in the in-vehicle communication system 1 according to the present embodiment, the two communication lines 6 that connect the two GWs 10 are communication lines following the same communication protocol. In this way, there is no need for processing to convert the message format to the different communication protocols of the GWs 10, for example, and communication delay caused by conversion processing can be prevented. Furthermore, the configuration of the GW 10 can be prevented from becoming too complex, thus minimizing or preventing an increase in the cost of the GW 10.

Also, in the in-vehicle communication system 1 according to the present embodiment, the relationships between the IDs that are attached to the messages and the communication lines 6 corresponding to the transmission destinations of the messages are stored in the transmission destination map 12b of the storage unit 12 by the GW 10. In the case in which a message is received that is to be transmitted to the other GW 10, the GW 10 selects the communication line 6 as the transmission destination on the basis of the relationships stored in the transmission destination map 12b, outputs the message to the selected communication line 6, and transmits the message to the other GW 10. Also, the GW 10 monitors the communication status at the plurality of communication lines 6 connected to the other GW 10. For the monitored communication status, for example, the data amount of the messages transmitted and received at the communication line 6, power consumption of the communication unit 14, and the like can be used. The GW 10 executes processing to update the relationships stored in the transmission destination map 12b of the storage unit 12 on the basis of the results from monitoring the communication status. In this way, the relationships between the messages and the communication lines 6 for transmitting the messages can be changed by the GW 10 depending on the communication status, and by resolving an imbalance in the communication amount between the communication lines 6, the communication band can be used effectively.

The GW 10 according to the first embodiment executes processing to update the relationships stored in the transmission destination map 12b of the storage unit 12 each time a predetermined unit time elapses. In this way, the relationships can be reviewed each time the unit time elapses, and the relationships can be updated to be appropriate to the communication status at that point in time.

Also, the GW 10 according to the first embodiment updates the relationships stored in the transmission destination map 12b of the storage unit 12 so that a message allocated to the communication line 6 with a larger amount of transmission data is allocated to the communication line 6 with a smaller amount of transmission data. By resolving an imbalance in the amount of transmission data between the two communication lines provided between the two GWs 10 in this manner, the communication band can be used effectively.

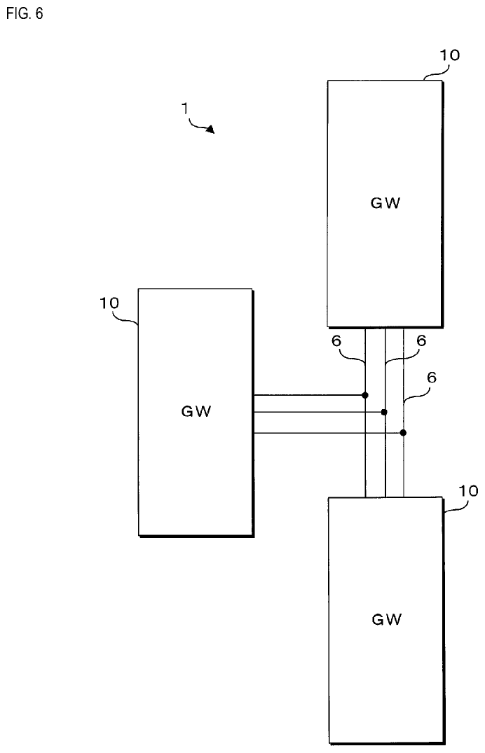

Note that in the present embodiment, the in-vehicle communication system 1 has a configuration in which two GWs 10 are provided and the two GWs 10 are connected to one another via the two communication lines 6. However, the system configuration is not limited thereto. The in-vehicle communication system 1 may be provided with three or more GWs 10, and the plurality of GWs 10 may be connected to one another via three or more communication lines 6. FIG. 6 is a schematic diagram illustrating the configuration of the in-vehicle communication system 1 according to a modified example. In the in-vehicle communication system 1 according to the modified example, three GWs 10 are provided. Though omitted from FIG. 6, a plurality of communication lines 5 are connected to each GW 10, and one or more ECUs 3 are connected to each communication line 5. Also, the three GWs 10 are connected to one another via three communication lines 6. The three communication lines 6, for example, follow a CAN communication protocol, and the three GWs 10 are connected to one another via the communication lines 6 using a bus connection method. Note that the GWs 10 may be connected using a connect method other than a bus connection method, such as a by a ring system or a star system.

### Second Embodiment

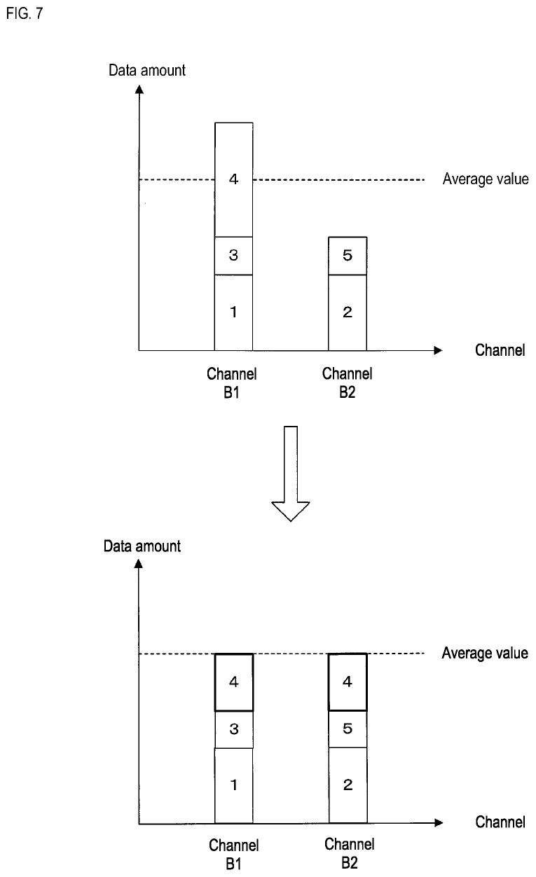

In the in-vehicle communication system 1 according to a second embodiment, the update processing unit 23 updates the transmission destination map 12b via a different method than in the first embodiment. FIG. 7 is a schematic diagram illustrating an example of processing to update the transmission destination map 12b executed by the GW 10 according to the second embodiment. In the example of the upper graph of FIG. 7, messages with the ID “1”, “3”, “4” have the channel B1 set as the second transmission destination and messages with the ID “2”, “5” have the channel B2 set as the second transmission destination. The channel B1 has a larger amount of transmission data per unit time.

In the GW 10 according to the second embodiment, the channel B1 and B2 can both be set as the second transmission destination of the message. In the case in which a message with the channel B1 and B2 both set as the second transmission destination is transmitted, the relay processing unit 21 of the GW 10 according to the second embodiment, instead of transmitting the message from both the channel B1 and B2, either the channel B1 or the channel B2 is selected and then the message is transmitted. The relay processing unit 21, for example, may select the channel B1 and B2 alternately as the transmission destination or, for example, one may be selected on the basis of a generated random number.

The update processing unit 23 of the GW 10 according to the second embodiment, each time a unit time elapses, acquires the amount of transmission data of each channel measured by the monitor processing unit 22 and calculates the average value of the amount of transmission data of the two channels. The update processing unit 23 selects one message from the messages allocated to the channel with a larger amount of transmission data and sets the second transmission destination of the selected message to both the channel B1 and B2. Here, the update processing unit 23 may select the message with the largest amount of transmission data from among the messages allocated to the channel with a larger amount of transmission data.

In the example illustrated in the lower graph in FIG. 7, from among the messages allocated to the channel B1 with a larger amount of transmission data, the message with the ID “4” which has the largest amount of transmission data is selected by the update processing unit 23, and the second transmission destination of this message is set to both channel B1 and B2. The update processing unit 23 changes the second transmission destination of the message with the ID “4” included in the transmission destination map 12b of the storage unit 12 to the channel B1 and the channel B2. In this way, the amount of transmission data of the message with the ID “4” is distributed between the channel B1 and B2, and the amount of transmission data of the two channels is evened out.

The GW 10 according to the second embodiment having the configuration described above allocates a message with a predetermined ID allocated to the communication line 6 with a larger amount of transmission data to a plurality of communication lines 6. In this way, the communication load can be distributed from the communication line 6 with a larger amount of transmission data to the communication line 6 with a smaller amount of transmission data, and an imbalance in the amount of transmission data between the plurality of communication lines 6 can be resolved. Note that in the case in which a message with both the channel B1 and B2 allocated as the second transmission destination is transmitted, the relay processing unit 21 need not transmit the message using the two channels B1 and B2 evenly. For example, the channels may be selected with a bias of a 2 to 1 ratio, for example, and the message may be transmitted.

Other configurations of the in-vehicle communication system 1 according to the second embodiment are similar to that of the in-vehicle communication system 1 according to the first embodiment. Thus, similar components are denoted with the same reference sign, and detailed description is omitted.

### Third Embodiment

In the in-vehicle communication system 1 according to a third embodiment, the update processing unit 23 of the GW 10 executes the processing to update the transmission destination map 12b at a different timing than in the in-vehicle communication system 1 according to the first embodiment. The in-vehicle communication system 1 according to the third embodiment, instead of executing update processing each time a unit time elapses, executes update processing when an imbalance level in the amount of transmission data between the two communication lines 6 connecting the two GWs 10 exceeds a threshold. The GW 10 according to the third embodiment does not execute update processing unless the imbalance level exceeds the threshold.

The monitor processing unit 22 of the GW 10 according to the third embodiment measures the amount of transmission data of each of the communication lines 6 per a unit of time ranging from hundreds of milliseconds to seconds, for example and calculates the imbalance level between the communication lines 6. The imbalance level may be calculated on the basis of Formula (1) below, for example. Note that, in Formula (1), “UB” is the imbalance level, “Da” is the average value of the amount of transmission data at the plurality of communication lines 6, and “D” is the amount of transmission data of the communication line 6 with the amount of transmission data most different from the average value Da. In the present example, the two GWs 10 are connected to one another via the two communication lines 6. Thus, “D” is the amount of transmission data of one of the communication lines 6.

UB=|D−Da|/Da (1)

The update processing unit 23 of the GW 10 according to the third embodiment executes processing to update the relationships stored in the transmission destination map 12b of the storage unit 12 when the imbalance level calculated by the monitor processing unit 22 exceeds a preset threshold a. The threshold a is predetermined at the design stage of the in-vehicle communication system 1, for example. The update processing executed by the update processing unit 23 is similar to the update processing of the first embodiment and the second embodiment described above.

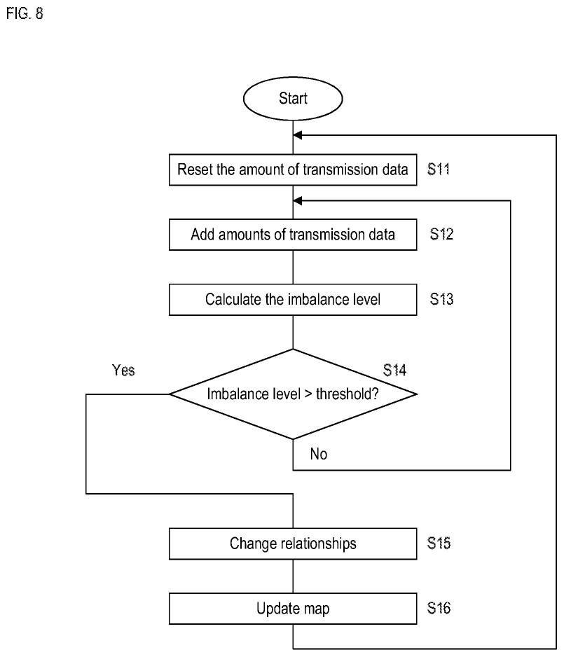

FIG. 8 is a flowchart illustrating the process of processing to update the transmission destination map 12b executed by the GW 10 according to the third embodiment. The monitor processing unit 22 of the processing unit 11 of the GW 10 according to the third embodiment measures the amount of transmission data of the two channels via which communication with the other GW 10 is executed and, firstly, resets the amount of transmission data, i.e., the measurement results (step S11). Next, the monitor processing unit 22 adds together the amount of transmission data of each channel corresponding to the message transmission from each channel (step S12). The monitor processing unit 22 calculates the imbalance level using Formula (1) described above on the basis of the amount of transmission data of each channel (step S13). The monitor processing unit 22 determines whether or not the calculated imbalance level exceeds the predetermined threshold (step S14). If the imbalance level does not exceed the threshold (S14: NO), the monitor processing unit 22 returns the process to step S12.

If the imbalance level exceeds the threshold (S14: YES), the update processing unit 23 of the processing unit 11 changes the relationships of the messages to the channels so that the amount of transmission data of each channel moves closer to the average value (step S15). The update processing unit 23 updates the transmission destination map 12b of the storage unit 12 to reflect the changed relationships (step S16), and the process returns to step S11.

The in-vehicle communication system 1 according to the third embodiment with the configuration described above calculates the imbalance level of the communication status for the plurality of communication lines 6 connecting the plurality of GWs 10, and, in the case in which the imbalance level exceeds the threshold, the update processing unit 23 executes processing to update the relationships stored in the transmission destination map 12b. Because update processing is not executed when the communication status is in a balanced state in this manner, the frequency in which update processing is executed can be reduced and the processing load and power consumption of the GW 10 can be reduced.

Note that Formula (1) for calculating the imbalance level described in the third embodiment is an example, and the imbalance level may be calculated by a different calculation method. Also, instead of determining whether or not to execute update processing on the basis of the imbalance level, a different value may be calculated and used. The GW 10, for example, may execute update processing in the case of a balance level of the communication status being a threshold or less or in the case of the difference between the maximum value and the minimum value of the amount of transmission data exceeding a threshold. The update processing may also be executed on the basis of values other than these.

Other configurations of the in-vehicle communication system 1 according to the third embodiment are similar to that of the in-vehicle communication system 1 according to the first embodiment. Thus, similar components are denoted with the same reference sign, and detailed description is omitted.

The devices of the in-vehicle communication system are provided with a computer that includes a microprocessor, ROM, RAM, and the like. The computation processing unit of the microprocessor or the like is executed by reading out a computer program including a portion or all of the steps of the sequence diagram or flowchart such as those illustrated in FIG. 5 and FIG. 8 from a storage unit, such as ROM, RAM, or the like. The computer program of these devices may be installed from an external server device or the like. Also, the computer program of these devices may be distributed while stored in a recording medium, such as a CD-ROM, a DVD-ROM, a semiconductor memory, and the like.

The embodiments disclosed herein are examples in all respects and should not be interpreted as limiting in any manner. The present disclosure is defined not by the foregoing description, but by the scope of the claims, and all modifications that are equivalent to or within the scope of the claims are included.

1. An in-vehicle communication system, comprising:
a plurality of in-vehicle relay devices, each one including:
a plurality of first connection units, an in-vehicle communication device being connected to each one of the first connection units;
a plurality of second connection units to which another one of the in-vehicle relay devices is connected; and
a relay processing unit configured to execute processing to relay messages between the in-vehicle communication devices connected to the first connection units and the other one of in-vehicle relay devices connected to the second connection units, wherein
two of the in-vehicle relay devices are connected to one another via two or more communication lines.

2. The in-vehicle communication system according to claim 1, wherein the two or more communication lines connecting the two in-vehicle relay devices follow an identical communication protocol.

3. The in-vehicle communication system according to claim 1, wherein the in-vehicle relay devices each include:
a storage unit configured to store relationships between identification information attached to messages received via the first connection units and the second connection units corresponding to transmission destinations of the messages;
a monitor processing unit configured to execute processing to monitor a communication status of communication via the second connection units; and
an update processing unit configured to execute processing to update the relationships according to the communication status monitored by the monitor processing unit.

4. The in-vehicle communication system according to claim 3, wherein the update processing unit executes processing to update the relationships each time a predetermined amount of time elapses.

5. The in-vehicle communication system according to claim 3, wherein the update processing unit executes processing to update the relationships when an imbalance level of the communication status of communication via the second connection units exceeds a threshold.

6. The in-vehicle communication system according to claim 3, wherein the update processing unit updates the relationships so that a message allocated to a second connection unit of the second connection units with a larger communication amount is allocated to a second connection unit of the second connection units with a smaller communication amount.

7. The in-vehicle communication system according to claim 3, wherein the update processing unit updates the relationships so that a message with a predetermined identification information allocated to a second connection unit of the second connection units with a larger communication amount is transmitted via the plurality of second connection units.

8. An in-vehicle relay device, comprising:
a plurality of first connection units, an in-vehicle communication device being connected to each one of the first connection units;
a plurality of second connection units to which another in-vehicle relay device is connected; and
a relay processing unit configured to execute processing to relay messages between the in-vehicle communication devices connected to the first connection units and the other in-vehicle relay device connected to the second connection units.

9. A communication program product comprising a non-transitory, machine-readable medium storing instructions which, when executed by at least one programmable processor causes an in-vehicle relay device, which is provided with a plurality of first connection units, an in-vehicle communication device being connected to each one of the first connection units, and a plurality of second connection units to which another in-vehicle relay device is connected, wherein two or more of the second connection units are connected to the other in-vehicle relay device,
to execute processing to:
receive messages from the in-vehicle communication devices via the first connection units; and
relay received messages to the other in-vehicle relay device via one or the plurality of second connection units.

10. A communication method, comprising:
via an in-vehicle relay device provided with a plurality of first connection units, an in-vehicle communication device being connected to each one of the first connection units, and a plurality of second connection units to which another in-vehicle relay device is connected, wherein two or more of the second connection units are connected to the other in-vehicle relay device,
receiving messages from the in-vehicle communication devices via the first connection units; and
relaying received messages to the other in-vehicle relay device via one or the plurality of second connection units.
